(19) United States
(12) Patent Application Publication
(10) Pub. No.: US 2008/0085833 A1
(43) Pub. Date: Apr. 10, 2008

(54) Use Of Glycerol As An Anti-Moss And/Or Anti-Lichen Agent

(76) Inventor: Bernard Parant, Ozoir La Ferriere (FR)

Correspondence Address: HAMRE, SCHUMANN, MUELLER & LARSON, P.C., P.O. BOX 2902, MINNEAPOLIS, MN, 55402-0902, US

(21) Appl. No.: 11/792,442

(22) PCT Filed: Dec. 5, 2005
(86) PCT No.: PCT/FR05/51035

§ 371 Date: Aug. 29, 2007

(30) Foreign Application Priority Data
Dec. 6, 2004 (FR) 0412935

(51) Int. Cl. A01N 31/00; A01N 37/00

(52) U.S. Cl. 504/320; 504/353

(57) ABSTRACT

The present invention relates to the use of glycerol as an anti-moss and/or anti-lichen agent. The present invention further relates to a process for the treatment of a surface covered with mosses and/or lichens by using glycerol or a glycerol composition in aqueous solution containing a surfactant and/or an organic acid or one of its salts.

The present invention relates to the use of glycerol as an anti-moss and/or anti-lichen agent.

The present invention relates more particularly to the use of glycerol for the preparation of a composition for removing mosses and/or lichens.

Finally, the present invention relates to a process for the treatment of a surface covered with mosses and/or lichens, using glycerol.

Lichens are chlorophyllous plants which develop on a variety of substrates such as, in particular, wood, stone, tiles and glass. Their formation results from the symbiosis between a unicellular alga and a fungus, which is most often an ascomycete.

Mosses are small chlorophyllous plants, a few centimeters in length, which generally live in damp shady places.

Thus the presence of mosses and/or lichens on facades or floors or at the base of walls is often a sign of constant or repeated dampness.

Lichens and mosses are capable of colonizing numerous materials and can harm the integrity of facades or floors, for example, when they have been implanted for very long periods.

Mosses and/or lichens are also considered undesirable on numerous surfaces which become dangerous and slippery.

Only a few solutions have been proposed for preventing the proliferation of mosses and/or lichens or, at best, for removing them under reasonable ecotoxic conditions.

Several techniques exist for cleaning facades and/or concrete floors.

The most widely used techniques probably consist in cleaning the surfaces by spraying them with liquids or abrasive agents under pressure or by applying chemicals. Most of these techniques can damage the integrity of the covering on the treated surfaces.

The chemicals that are ordinarily employed for cleaning masonry are very corrosive and often toxic. It may be necessary to employ special apparatuses to apply them and to wear protective overalls during the application. Furthermore, their use requires that other parts of the building, as well as surrounding trees and shrubs, be protected.

The bio-organic coverings represented by mosses and lichens can also be removed with the aid of anti-moss chemicals or lichenicides.

However, the majority of commercial products are based on sodium hypochlorite or quaternary ammonium salts and can be harmful to the treated surface (acceleration of corrosion phenomena), toxic to lawns and plants and also dangerous for the user (risk of burns).

Facades can also be cleaned by mechanical “stripping” of the products covering them. Thus, for cleaning facades, the document “Comparative study of cleaning techniques applied to ancient concrete” (Research laboratory for historic monuments; CAN 134: 241456 AN 2001: 90805) teaches the use of glycerol/polyvinyl alcohol, which polymerizes after application to the surface to be treated and allows mechanical cleaning by peeling off the polymerized film.

The problem therefore arose of finding a means of removing mosses and/or lichens accumulating on the surface of walls, roofs and/or floors, without degrading the environment and without harming the treated surface.

The Applicant has surprisingly discovered that glycerol has an anti-moss and/or anti-lichen activity that enables this object to be achieved.

Glycerol is an odorless, colorless, viscous liquid product at room temperature. Also, it is particularly biodegradable in a humid atmosphere.

Glycerol is used in a multitude of pharmaceutical, cosmetic and industrial products. Moreover, it is itself a by-product of the manufacture of soaps and candles.

Glycerol is employed e.g. as a fabric softener, but also as a drying retarder for various water-based paints, or else as a lubricant.

No document of the state of the art either discloses or suggests its possible use as an anti-moss or anti-lichen agent.

It has therefore been discovered that glycerol and compositions containing it exhibit anti-moss and anti-lichen effects, and it is this which constitutes the basis of the present invention.

The present patent application further aims to cover the use of glycerol for the preparation of a composition for removing mosses and/or lichens.

These compositions preferably contain from 99% to 20% by weight of glycerol in aqueous solution.

These compositions preferably contain 65% technical-grade glycerol.

Advantageously, the pH of these compositions is between 5 and 9.

The efficacy of the glycerol, e.g. its wetting character, can be improved by adding a surfactant to the composition.

The wetting power of a product is its capacity to spread over a surface.

The surfactant can be selected from the group comprising known non-ionic and ionic detergents.

The most active surfactants within the framework of the invention are advantageously selected from ethoxylated alcohols, particularly polyoxyethylene 2-ethylhexyl ether, sodium dioctylsulfosuccinate, lauryl ether sulfate and alkyl polyglucosides (C₈ chain).

The compositions of the present invention preferably contain from 0.1 to 5% by weight of a surfactant.

In one particular embodiment, the compositions of the present invention also contain an organic acid to increase the “scouring” efficacy, particularly when the lichens and mosses are clinging to chalky substrates, thereby facilitating their removal.

The organic acids which can be used within the framework of the invention are selected, in order of efficacy, from gluconic acid, propionic acid, lactic acid, acetic acid, formic acid, citric acid and one of their salts.

The compositions of the present invention preferably contain from 0.5 to 5% by weight of an organic acid or one of its salts.

A preferred composition prepared in this way according to the invention comprises glycerol mixed with 0.5 to 5% by weight of gluconic acid or one of its salts, preferably sodium gluconate.

The glycerol and/or the compositions containing it which form the subjects of the present invention are useful in particular for treating lichens that belong, without implying a limitation, to the group comprising crustaceous lichens, filamentous lichens, bushy lichens and/or gelatinous lichens.

Examples which may be mentioned are common orange lichen (Xanthoria parietina), Caloplaca marina, acarospore (Acarospora chlorophana), gray parmelia (Hypogymnia physodes), cloak parmelia (Parmelia caperata), Parmelia sulcata, foliose lichens (Physcia), coppery parmelia (Parmelia acetabulum), crustaceous lichens (Lecanora), Aspicilia contorta, Xanthoparmelia, Rhizoplaca chrysoleuca and Rhizoplaca melanophthera.

Likewise, the mosses which can be treated with the glycerol and/or the compositions of the present invention belong, without implying a limitation, to the groups comprising Leucobryum, Bryum, Mnium, Andreales and Sphagnales.

According to another feature, the invention further relates to a process for the treatment of a surface covered with mosses and lichens, using glycerol.

The process according to the invention for removing mosses and lichens generally consists in applying a composition containing from 99% to 20% by weight of glycerol to a surface, specifically manually or mechanically (using a low-pressure sprayer).

The amount of anti-moss and/or anti-lichen product to be used depends on the surface area and the density of mosses and/or lichens present on the surface to be treated.

In general, 1 liter of a glycerol-based composition is sufficient to treat an area of 5 to 20 m².

The composition applied in this way is then allowed to act for a period of 24 to 48 hours.

It is not necessary to carry out a rough cleaning of the surface to be treated (with a brush or spatula) before applying the product.

It has been found that the removal of mosses and lichens according to the invention is facilitated by sunny climatic conditions.

Rain is therefore an unfavorable factor in the process according to the invention for the treatment of a surface contaminated with lichens and/or mosses.

The treatment can be repeated periodically according to the exposure of the substrates.

The composition according to the invention acts within 24 to 48 hours, preferably 24 hours.

This affords a more or less rapid, natural removal of mosses and lichens. The removal rate will depend on the atmospheric conditions (wind and washing by rain) and will vary from a few days to a few weeks.

These plants can also be removed by gentle brushing.

The process according to the invention can be carried out on different surfaces, among which the following may be mentioned in particular: cement, concrete, slate, stone, tiles and the surfaces of tennis courts or athletics tracks.

The invention is illustrated in greater detail in the non-limiting Examples which follow.

### EXAMPLE 1

Glycerol-based compositions for removing mosses and/or lichens

Formulation 1

| | |
|---|---|
| Glycerol | 65% |
| Water | 35% |

Formulation 2

| | |
|---|---|
| Glycerol | 50% |
| Gluconic acid | 5% |
| Polyoxyethylene 2-ethylhexyl ether | 2% |
| Water | 43% |

Formulation 3

| | |
|---|---|
| Glycerol | 50% |
| Sodium gluconate | 5% |
| Polyoxyethylene 2-ethylhexyl ether | 2% |
| Water | 43% |

Formulation 4

| | |
|---|---|
| Glycerol | 50% |
| Sodium gluconate | 5% |
| Sodium dioctylsulfosuccinate | 0.2% |
| Water | 44.8% |

Formulation 5

| | |
|---|---|
| Glycerol | 50% |
| Sodium gluconate | 5% |
| Sodium lauryl ether sulfate | 1% |
| Water | 44% |

Formulation 6

| | |
|---|---|
| Glycerol | 50% |
| Propionic acid | 1% |
| Polyoxyethylene 2-ethylhexyl ether | 2% |
| Water | 47% |

Formulation 7

| | |
|---|---|
| Glycerol | 20% |
| Propionic acid | 2% |
| Polyoxyethylene 2-ethylhexyl ether | 3% |
| Water | 75% |

### EXAMPLE 2

The properties of the compositions according to the present invention were demonstrated by performing the experiment described below.

### EXPERIMENT NO. 1

### Demonstration of the Anti-Moss and Anti-Lichen Effect of the Glycerol-Based Compositions

An anti-moss and/or anti-lichen composition is first prepared by solubilizing the required amount of glycerol in water at room temperature, in an appropriate vessel, to give a solution containing 99%, 65% or 20% by weight of glycerol.

The anti-moss and/or anti-lichen composition is maintained at this same temperature in a vessel fitted with a nozzle to enable the product to be sprayed onto a vertical or horizontal surface.

The composition containing the glycerol is appropriate for immediate use or for long-term storage.

A sufficient amount of anti-moss and/or anti-lichen composition containing 99%, 65% or 20% by weight of glycerol, with or without gluconic acid, is applied by the process of the invention to 3 different surfaces covered with crustaceous lichens, gelatinous lichens and mosses.

For the series of 3 treatments, visual observations were made periodically after treatment with the glycerol compositions described, and then at regular intervals for 3 weeks.

Results:

For the gelatinous lichens, the green thalli covering the surface treated with all the glycerol-based compositions, with or without detergent, are almost completely removed after 5 days.

For the crustaceous lichens, a color change of the thalli (from yellow to greenish-brown) is observed after 17 hours of treatment with all the glycerol-based compositions, with or without detergent.

For the mosses, a browning is observed 4 days after treatment with all the glycerol-based compositions, with or without detergent.

After a period of between 24 hours and 48 hours, a change in appearance of the mosses and lichens is observed, compared with the untreated mosses and lichens. The color of the mosses and lichens changes from green to light brown and then to dark brown. In this last stage the mosses and lichens gradually come away from their substrate.

The mosses and lichens are removed without any mechanical action over time. However, this removal can be accelerated by mechanical sweeping or the application of a water jet. No regrowth of the mosses and lichens is observed 3 months after their removal.

### CONCLUSION

Pure glycerol is effective for removing mosses and/or lichens. The glycerol can be diluted to 20% without losing its anti-moss and/or anti-lichen activity.

A composition containing 5% of gluconic acid and 95% of glycerol is slightly more active than pure glycerol on crustaceous lichens. No improvement was demonstrated between the solution containing 20 or 65% of glycerol and pure glycerol (99% by weight) in the removal of gelatinous lichens.

In general terms, an improvement in the removal of mosses and/or lichens is observed when using a composition containing glycerol and an organic acid or one of its salts.

1. (canceled)

2. (canceled)

3. (canceled)

4. The process according to claim 13 wherein the pH of the abovementioned composition is between 5 and 9.

5. The process according to claim 13 wherein the composition comprises glycerol mixed with a surfactant selected from the group consisting of ethoxylated alcohols, sodium dioctylsulfosuccinate, lauryl ether sulfate and C₈ alkyl polyglucosides.

6. The process according to claim 13 wherein the composition comprises an organic acid selected from the group consisting of gluconic acid, propionic acid, lactic acid, acetic acid, formic acid, citric acid and their salts.

7. The process according to claim 6 wherein the organic acid is gluconic acid or one of its salts.

8. The process according to claim 7 wherein the organic acid salt is sodium gluconate.

9. The process according to claim 13 wherein the composition preferably contains 65% technical-grade glycerol.

10. The processes according to claim 13 wherein the mosses are selected from the group consisting of Leucobryum, Bryum, Mnium, Andreales and Sphagnales.

11. The process according to claim 13 wherein the lichens are selected from the group consisting of crustaceous lichens, filamentous lichens, bushy lichens and gelatinous lichens.

12. A composition for removing mosses and/or lichens which comprises glycerol mixed with 0.5 to 5% by weight of an organic acid or one of its salts.

13. A process for the treatment of a surface covered with mosses or lichens, which comprises applying to said surface a composition containing from 99% to 20% by weight of glycerol.

14. The process according to claim 13 wherein said surface is selected from cement, concrete, slate, stone, tiles and the surfaces of tennis courts or athletics tracks.

15. The process according to claim 13 or 14 comprising:
applying a sufficient amount of the composition for removing the mosses and/or lichens and
allowing the composition to act for a period of 24 to 48 hours without rain.

16. The process according to claim 13 wherein the composition comprises glycerol mixed with polyoxyethylene 2-ethylhexyl ether.
